(19) United States
(12) Patent Application Publication
(10) Pub. No.: US 2010/0201689 A1
(43) Pub. Date: Aug. 12, 2010

(54) METHOD, APPARATUS AND COMPUTER PROGRAM PRODUCT FOR INTERACTIVE SKETCH TEMPLATE CREATION, ALTERATION, AND USE

(75) Inventors: Hao Wang, Beijing (CN); Shiming Ge, Beijing (CN)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 12/339,707

(22) Filed: Feb. 9, 2009

(51) Int. Cl. G06T 11/20; G06K 9/62

(52) U.S. Cl. 345/442; 382/209

(57) ABSTRACT

A method is provided for converting a template creation input corresponding to an image into a sketch template. This method may include minimizing stroke data cost and converting the resulting contour into a curve approximation based around landmark points. After the sketch template is created, it may be personalized using various styles which alter the parameters of the curve approximation and/or the landmark points. The sketch template may be used to practice drawing skills. A tracing algorithm may provide feedback as to how far a tracing line deviates from the sketch template, and may also provide overall feedback for all the tracing lines combined, relating to factors such as closeness to the sketch template, speed, and completion percentage.

### TECHNOLOGICAL FIELD

Embodiments of the present invention relate generally to interactive sketch template technology and, more particularly, relate to a method, apparatus and computer program product for creating, altering, and using an interactive sketch template based on an image.

### BACKGROUND

The ability to draw well can be an important part of a person's skill set both for professional and recreational reasons. One method of improving drawing skills is that of sketch template tracing. This allows a person to practice tracing and have a template with which to compare the completed drawing. Sketch tracing can occur mechanically using a printed sketch template and a pencil or other writing instrument.

However, mechanical sketch tracing has several disadvantages: The sketch template can typically be used only once. The sketch template also cannot be easily modified. Further, only limited numbers and types of printed sketch templates exist. Finally, there is no formalized objective feedback to provide the person with an idea of how well he performed.

Accordingly, it would be desirable to provide for an improved technique for providing a sketch template including the provision of a number of sketch templates that may be reused and/or modified. It would also be desirable to provide feedback regarding a user's sketch with respect to the sketch template.

### BRIEF SUMMARY OF SOME EXAMPLES

Embodiments of the present invention address these issues and more. In one embodiment, a method, apparatus, and computer program product are provided for creating, altering, and using interactive sketch templates. Sketch templates may be created from any image, which allows the user to create a virtually unlimited number of sketch templates to suit the user's needs and desires. Further, as the sketch templates are electronic, they may be reused over and over again. Also, the templates may be altered to make them personalized and stylized to the user's tastes. Finally, formalized objective feedback may be provided to the user based on a number of criteria, and the feedback may be presented to the user in a number of different ways.

In one exemplary embodiment, an apparatus is provided that includes a processor configured to provide for a display of an image, receive a template creation input comprising one or more strokes and corresponding at least in part to the image, determine a lowest data cost contour corresponding to one stroke of the one or more strokes, translate the lowest data cost contour into a curve approximation, and provide a sketch template that comprises at least the curve approximation.

Additionally, the processor may be configured to output tracing feedback based at least in part on one or more differences between the sketch template and a tracing input. The processor may also be configured to output the tracing feedback substantially instantaneously. The processor may additionally be configured to calculate and provide for display of a completion value that indicates how much of the sketch template has been traced by the tracing input. Moreover, the processor may be configured to provide for conversion of one or more of the strokes from a closed condition to an open condition. Furthermore, the processor may be configured to modify one or more characteristics of the curve approximation so as to customize the sketch template. The processor may further be configured to provide for capture of the image prior to its display. Also, the processor may be configured to provide for transmission of the sketch template and reception of an externally created sketch template.

In another exemplary embodiment, a method for creating, altering, and using an interactive sketch template is provided. This method may include providing for a display of an image, receiving a template creation input comprising one or more strokes and corresponding at least in part to the image, determining a lowest data cost contour corresponding to one stroke of the one or more strokes, translating the lowest data cost contour into a curve approximation, and providing a sketch template that comprises at least the curve approximation. The method may further include outputting a tracing feedback based at least in part on one or more differences between the sketch template and a tracing input. The method may additionally include calculating and providing for display of a completion value that indicates how much of the sketch template has been traced by the tracing input. The method may also include differentiating one or more portions of the tracing input based on a distance between the tracing input and one or more corresponding portions of the sketch template. Finally, the method may include modifying one or more characteristics of the curve approximation so as to customize the sketch template.

In another exemplary embodiment, a computer program product for creating, altering, and using a sketch template comprising at least one computer-readable storage medium having computer-executable program instructions stored therein is provided. The computer-executable program instructions may include a program instruction configured to provide for display of an image, a program instruction configured to receive a template creation input comprising one or more strokes and corresponding at least in part to the image, a program instruction configured to determine a lowest data cost contour corresponding to one stroke of the one or more strokes, a program instruction configured to translate the lowest data cost contour into a curve approximation, and a program instruction configured to provide a sketch template that comprises at least the curve approximation.

The computer-executable program instructions may further include program instructions configured to output a tracing feedback based at least in part on one or more differences between the sketch template and a tracing input. The computer-executable program instructions may additionally include program instructions configured to calculate and provide for display of a completion value that indicates how much of the sketch template has been traced by the tracing input. The computer-executable program instructions may also include program instructions configured to differentiate one or more portions of the tracing input based on a distance between the tracing input and one or more corresponding portions of the sketch template. Finally, the computer-executable program instructions may also include program instructions configured to modify one or more characteristics of the curve approximation so as to customize the sketch template.

Embodiments of the invention may provide a method, apparatus and computer program product for employment, for example, in mobile or fixed environments. As a result, for example, mobile terminal users may enjoy an improved capability for sketch template creation, alteration, and use.

### BRIEF DESCRIPTION OF THE SEVERAL VIEWS OF THE DRAWING(S)

Having thus described some embodiments of the invention in general terms, reference will now be made to the accompanying drawings, which are not necessarily drawn to scale, and wherein:

FIG. 1 illustrates a block diagram of a mobile terminal that may benefit from exemplary embodiments of the present invention;

FIG. 2 shows a block diagram illustrating a method of creating, modifying, and using a sketch template according to an exemplary embodiment of the present invention;

FIG. 3 illustrates a block diagram showing a method of computing contours based on input strokes as provided in accordance with one embodiment of the present invention;

FIG. 4 shows an example of a partially traced sketch template and the resulting feedback as provided in accordance with one embodiment of the present invention; and

FIG. 5 illustrates a block diagram showing the operation of a feedback method of an exemplary embodiment of the present invention.

### DETAILED DESCRIPTION OF SOME EMBODIMENTS OF THE INVENTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as used herein, is not provided to convey any qualitative assessment, but instead merely to convey an illustration of an example. Thus, use of any such terms should not be taken to limit the spirit and scope of embodiments of the present invention.

Some embodiments of the present invention may provide a mechanism by which improvements may be experienced in relation to sketch templates. In this regard, for example, some embodiments may provide for interactive sketch template creation, alteration, and use and numerous other activities on hand-held or other computing devices.

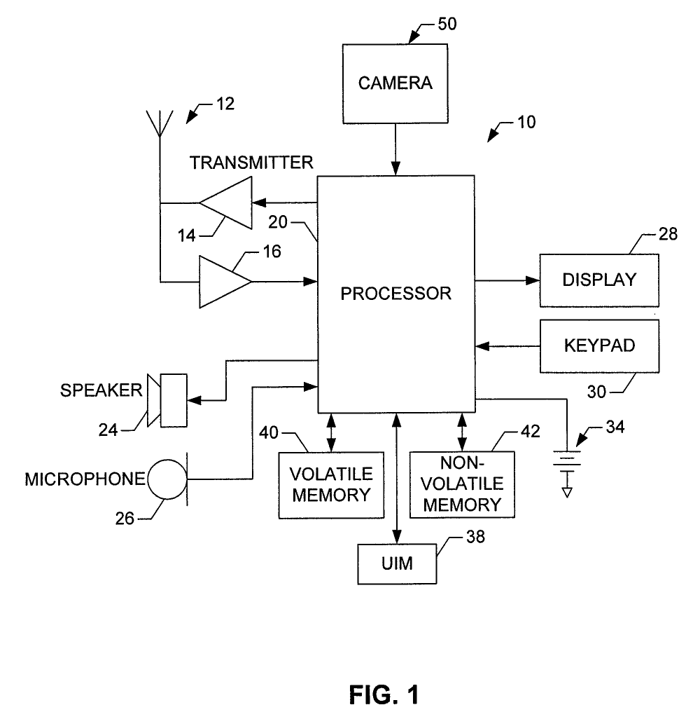

FIG. 1 illustrates a block diagram of a mobile terminal 10 that may benefit from embodiments of the present invention. It should be understood, however, that a mobile terminal 10 as illustrated and hereinafter described is merely illustrative of one type of device that may benefit from embodiments of the present invention and, therefore, should not be taken to limit the scope of embodiments of the present invention. While one embodiment of the mobile terminal 10 is illustrated and will be hereinafter described for purposes of example, other types of mobile terminals, such as portable digital assistants (PDAs), pagers, mobile computers, mobile televisions, gaming devices, laptop computers, cameras, video recorders, global positioning system (GPS) devices, mobile telephones, any combination of the aforementioned, and/or other types of voice and text communications systems, can readily employ embodiments of the present invention.

In addition, while several embodiments of the method of the present invention are performed or used by a mobile terminal 10, the method may be employed by other than a mobile terminal. In particular, other devices can function in accordance with embodiments of the present invention, regardless of their ability to communicate either wirelessly or via a wired connection and regardless of their mobility. Moreover, the system and method of embodiments of the present invention will be primarily described in conjunction with mobile communications applications. It should be understood, however, that the system and method of embodiments of the present invention may be utilized in conjunction with a variety of other applications, both in the mobile communications industries and outside of the mobile communications industries.

The mobile terminal 10 of the illustrated embodiment may include an antenna 12 (or multiple antennas) in operable communication with a transmitter 14 and a receiver 16. The mobile terminal 10 may further include an apparatus, such as a processor 20 or other processing element, that may provide signals to and receive signals from the transmitter 14 and receiver 16, respectively. The signals may include signaling information in accordance with the air interface standard of the applicable cellular system, and/or may also include data corresponding to speech, received data and/or user generated/transmitted data. In this regard, the mobile terminal 10 may be capable of operating with one or more air interface standards, communication protocols, modulation types, and access types. By way of illustration, the mobile terminal 10 may be capable of operating in accordance with any of a number of first, second, third and/or fourth-generation communication protocols or the like. As an alternative (or additionally), the mobile terminal 10 may be capable of operating in accordance with non-cellular communication mechanisms. For example, the mobile terminal 10 may be capable of communication in a wireless local area network (WLAN) or other communication networks. As noted above, some embodiments of the invention do not necessitate communication capabilities, let alone wireless communications, at all.

The processor 20 may include circuitry implementing, among others, audio, image, and logic functions of the mobile terminal 10. For example, the processor 20 may be embodied as various processing means such as a processing element, a coprocessor, a controller or various other processing devices including integrated circuits such as, for example, an ASIC (application specific integrated circuit), an FPGA (field programmable gate array), a hardware accelerator, or the like. In an exemplary embodiment, the processor 20 may be configured to execute instructions stored in memory 40, 42 or otherwise accessible to the processor 20. As such, whether configured by hardware or software methods, or by a combination thereof, the processor 20 may represent an entity capable of performing operations according to embodiments of the present invention while configured accordingly.

The mobile terminal 10 may also comprise a user interface including an output device such as an earphone or speaker 24, a microphone 26, a display 28, and a user input interface, which may be operationally coupled to the processor 20. The user input interface, which allows the mobile terminal 10 to receive data, may include any of a number of devices allowing the mobile terminal 10 to receive data, such as a keypad 30 or other input device. Also, the display 28 could comprise a touch screen input device. In embodiments including the keypad 30, the keypad 30 may include numeric (0-9) and related keys (#, *), and other hard and soft keys used for operating the mobile terminal 10. Alternatively, the keypad 30 may include a QWERTY keypad arrangement. The keypad 30 may also include various soft keys with associated functions. In one embodiment, the display and the user input interface may both be provided, at least partially, by a touch screen. In addition, or alternatively, the mobile terminal 10 may include an interface device such as a joystick or other user input interface. The mobile terminal 10 may further include a battery 34, such as a vibrating battery pack, for powering various circuits that are used to operate the mobile terminal 10, as well as optionally providing mechanical vibration as a detectable output. Also, the mobile terminal may include a camera 50 for taking photos.

The mobile terminal 10 may further include a user identity module (UIM) 38, which may generically be referred to as a smart card. The UIM 38 may be a memory device having a processor built in. The UIM 38 may include, for example, a subscriber identity module (SIM), a universal integrated circuit card (UICC), a universal subscriber identity module (USIM), a removable user identity module (R-UIM), or any other smart card. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which may be embedded and/or may be removable. The non-volatile memory 42 may additionally or alternatively comprise an electrically erasable programmable read only memory (EEPROM), flash memory, other non-volatile RAM (NVRAM) or the like. Non-volatile memory 42 may also include a cache area for the temporary storage of data. The memories 40, 42 can store any of a number of pieces of information, and data, used by the mobile terminal 10 to implement the functions of the mobile terminal. For example, the memories 40, 42 can include an identifier, such as an international mobile equipment identification (IMEI) code, capable of uniquely identifying the mobile terminal 10. Furthermore, the memories 40, 42 may store instructions for determining cell id information.

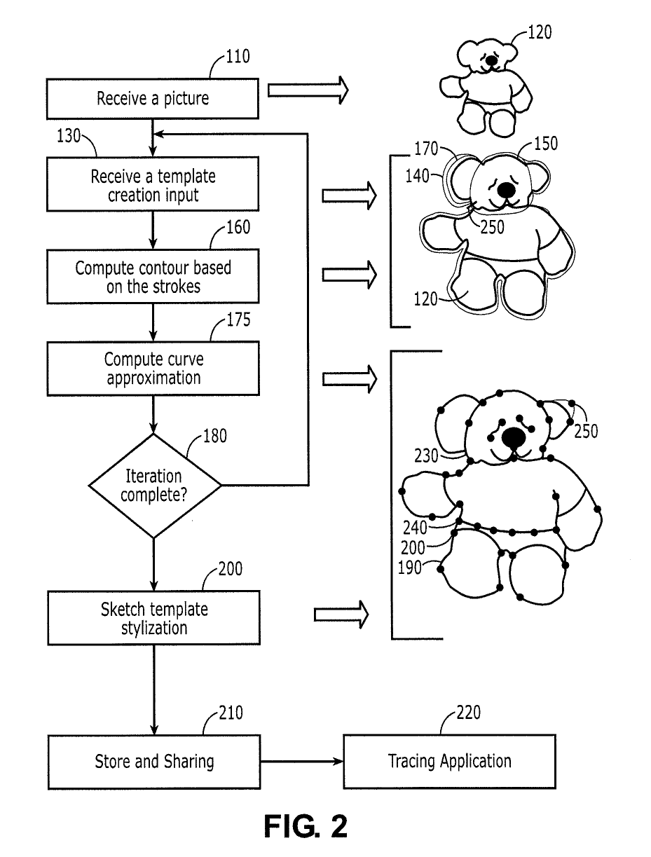

Returning to FIG. 2, there is shown a flowchart of a system, method and program product according to exemplary embodiments of the invention. It should be understood that the order of operations shown and described could be altered, and is described and shown in a particular order only for exemplary purposes. FIG. 2 relates in particular to overall methods of sketch template creation, alteration, and use. Initially, as shown in operation 110, a picture 120 or other image is received. Any image could be used, but for purposes of explanation, a photo 120 of a toy stuffed bear will be described. The photo 120 may be prestored and may simply be retrieved, such as locally from non-volatile memory 42 or from an external network which may be accessed, for example, via a wireless connection, using the antenna 12 in conjunction with the transmitter 14 and the receiver 16. Alternatively, the photo 120 may be an image that was captured moments before with the camera 50. Regardless of the origin of the photo 120, as shown in operation 130, a template creation input corresponding to the photo 120 may then be received from the user. This template creation input may be provided using any type of input device. One such input device may be a touch screen display 28 that would enable the user to draw strokes 140, 150, which may either be open 140 (i.e., they have two distinct ends), or closed 150 (i.e., they form a closed loop), directly on the photo 120 displayed on the screen. As shown in FIG. 2, the template creation input may trace the outline of an object (e.g., the bear) and features of the object (e.g., eyes, mouth, clothes, etc.) that the user desires to include in the template. After each stroke 140, 150 is drawn, the mobile terminal 10, such as using the processor, may then compute a lowest data cost path, as shown in operation 160, forming a contour 170 based on the strokes 140, 150. Details regarding how the contour 170 may be determined will be discussed below. Next, the processor may determine a curve approximation, as shown in operation 175. Details regarding the curve approximation will also be described below.

Thereafter, in one embodiment, the processor may determine whether an iteration, as shown in operation 180, has been completed for each stroke 140, 150, because the computation of a lowest data cost path, as shown in operation 160, forming a contour 170 and a curve approximation, as shown in operation 175, are carried out for each stroke individually. After all of the iterations, as shown in operation 180, have been completed, the combined result of the curve approximations is a sketch template 190. If desired, the sketch template 190 may be stylized. Stylization, as shown in operation 200, will be described in detail below, but briefly, it allows the user to alter the sketch template 190 as the user pleases. Before or after the sketch template 190 is stylized, as shown in operation 200, the sketch template may be stored and shared, as shown in operation 210, such as by sending the sketch template 190 to other users if so desired. As described in greater detail below, the processor may also execute a tracing application, as shown in operation 220, which allows the user to practice tracing the sketch template 190.

As noted above and shown in FIG. 2, in one embodiment, the processor may generate a contour 170, as shown in operation 160, and then compute a curve approximation, as shown in operation 175, after a user draws each stroke 140, 150 corresponding to the object in the photo 120. The generation of a contour, as shown in operation 160, and the computation of a curve approximation, as shown in operation 175, may be repeated, as shown in operation 180, for each stroke 140, 150 until the user completes the drawing. For a given stroke 140, 150, the processor may define the corresponding contour 170 as the minimal cumulative cost path defining the stroke. The processor may determine the contour 170 corresponding to a stroke 140, 150 in various manners. For example, the contour determination process may be formulated as a graph searching problem which could be solved by a two-dimensional dynamical programming algorithm called “Livewire”. See, for example, Mortensen, E. N. and Barrett, W. A. Intelligent scissors for image composition. ACM SIGGRAPH, pp. 191-198, 1995. However, in Livewire, the graph may need to be constructed over an entire photo when defining each seed point attaching to features of the photo, which may make real-time implementation somewhat challenging. In contrast, other embodiments of the present invention may construct a graph by only considering at a given time the portions of the template creation input that define an individual stroke 140, 150, which enables real-time contour generation, as shown in operation 160.

The Livewire algorithm has been extended to generate artistic sketches by repeatedly constructing a graph through following a user's interactive cursor movement and fixing seed points to features of a photo. However, in some cases, for example when defining long or closed contours, many seed points must be accurately placed with the cursor in order to extract the contours. In contrast, other embodiments of the present invention may ease the processing by searching for optimal data points and corresponding links within each stroke 140, 150 to form a lowest data cost contour 170, as shown in operation 160. In addition, embodiments of the present method may be fit to extract contours 170 from closed strokes 150, as will be described below.

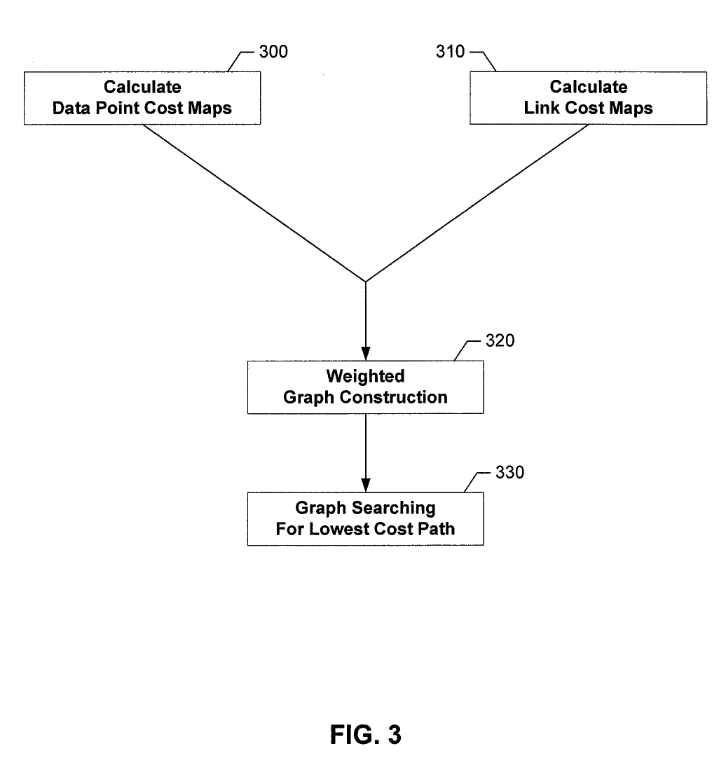

The contour computation performed by the processor of one embodiment is depicted in FIG. 3. In one embodiment, the contours 170 correspond to the most informative photo features such as edges, high gradient regions, areas with visual saliency, etc., and have some constraints such as smoothness, shape, topology, or constraints defined by users. Accordingly, the processor may compute two sets of cost maps 300, 310 for measuring the value of photo information. One set may be data point cost maps M_{P}{fₚ¹,fₚ², . . . } for evaluating the importance of each data point from the template creation input defining the strokes 140, 150. Map fₚⁱ(p) represents the data point cost in the ith data point cost map 300. As described above, many possible known importance measures for features of an image may be found in literature such as binary edge measures, feature detection measures, corner measures, saliency measures, L1 and L2 norm of gradient, image energy, curvature measures, etc. The optimality of a data point may be determined by computing the minimum cumulative data cost and therefore a “more informative” data point will have a lower data cost. The data point cost maps 300 may then be scaled into zeros and ones. Another set of cost maps may be link cost maps M_{L}={f_{L}¹,f_{L}², . . . } for calculating local link costs between data points in the strokes 140, 150. The link cost maps 310 may determine the data cost associated with the relationship between two neighboring data points such as gradient direction cost.

After constructing the cost maps, the processor, for a given stroke 140, 150 (denoted S in the formulas), may construct a weighted graph 320 G=(V,E), wherein V is the set of data points corresponding to the stroke, that is V={p|p ε S} and E is the set of links, that is E={(p,q)|p ε V,q ε V,q ε Nₚ}, where Nₚ stands for the neighboring data points beside data point p. Based on the cost maps 300, 310, defined above, the processor may define the cost of a link from data points p to q to be the weighted combination of several costs:

$$l ( p , q ) = {\sum }_{\{ {f}_{P}^{i} \} ⊆ {M}_{P}}^{ } {w}_{P}^{i} {f}_{P}^{i} ( q ) + {\sum }_{\{ {f}_{L}^{j} \} ⊆ {M}_{L}}^{ } {w}_{L}^{j} {D}_{j} ( {f}_{L}^{j} ( p ) , {f}_{L}^{j} ( q ) , p , q )$$

where weights corresponding to the cost maps 300, 310 are represented as w_{P}ⁱ and W_{L}^{j} which are used to balance the influences of each term. Dissimilarity function Dⱼ(•) may be used for measuring the diversity between link properties and stroke properties, and may also be normalized into zeros and ones. The processor may utilize graph searching 330 to find the minimum cumulative cost path for all paths traversing from start data points through all their connected data points to end data points. The cumulative cost of a path traversing a stroke 140, 150 may sum up the local link weights making up the path. A path P(p₁, pₙ)={p₁, p₂, . . . , pₙ} traversing a stroke 140, 150 may be represented as a set of n ordered data points. In this embodiment, data points p₁ and pₙ represent a start node and an end node, respectively, which define the ends of the path, and (pᵢ, pᵢ₊₁) ε E for i=1, 2, . . . , n−1. The processor may determine the cumulative cost of the path, such as according to the following equation:

$$L ( P ) = {\sum }_{\{ {f}_{P}^{i} \} ⊆ {M}_{P}}^{ } {w}_{P}^{i} {f}_{P}^{i} ( {p}_{1} ) + {\sum }_{i = 1}^{n - 1} l ( {p}_{1} , {p}_{i + 1} )$$

where the first term denotes the start point cost and the second term denotes total link cost. Since graph G is a two-dimensional grid, computing the shortest path from any data point to all others in the stroke 140, 150 may be achieved by two-dimensional dynamical programming with a complexity of O(N), where N is the number of data points in a stroke. The processor may choose data points from the two ends of the stroke 140, 150 to create a start node set Sₛ={pₛⁱ, i=1,2, . . . ,mₛ} and an end node set S_{E}={p_{E}^{j},j=1,2, . . . ,m_{E}}, where m_{S} and m_{E} are the number of start nodes and end nodes, respectively. Among the shortest paths starting from a first data point p_{S}ⁱεS_{S} and traveling through all of the connected data points in S_{E′}P(p_{S}ⁱ,p_{E}^{j}) is the one with the minimum cost. The processor may repeat the computation for all data points in Sₛ and may select the optimal contour 170 as the minimum cost path from {P(p_{S}ⁱ,p_{E}^{j})}. Assuming that the cost between two nonconnected data points is infinite, then the processor may define the optimal contour extraction, shown as operation 330, according to the following equation:

$${P}^{*} = {min}_{i = 1 , 2 , … , {m}_{s}} \{ {min}_{j = 1 , 2 , … , {m}_{E}} \{ L ( P ( {p}_{s}^{i} , {p}_{E}^{j} ) ) \} \}$$

The overall computational complexity is 0(mₛN). By collecting all the extracted contours 170, the processor may form a sketch template 190.

In order to support contour extraction from a closed stroke 150, as shown in FIG. 2, a straight line 250 of the smallest possible length may be used to break the continuity of the closed stroke, which minimizes the number of start nodes mₛ and reduces total computational complexity. All links crossing the straight line 250 in the closed stroke 150 may be ignored, which thus effectively converts the closed stroke into an open stroke 140. The start node set and the end node set are selected from the data points at opposite sides of the straight line 250. The last link cost may then be added by the processor to the start point cost which is thus computed as follows:

$$l ( {p}_{n} , {p}_{1} ) + {\sum }_{\{ {f}_{P}^{i} \} ⊆ {M}_{P}}^{ } {w}_{P}^{i} {f}_{P}^{i} ( {p}_{1} ) .$$

In some instances, the processor may further process the extracted contours 170. First, the contours 170 may not connect to one another despite the intent of the user. This disconnection may be corrected by creating a link between each pair of adjacent contours 170 using graph searching 330 as mentioned above. Second, the template creation input 130 may comprise zigzagging strokes 140, 150 due to poor stroke drawing. Accordingly, it may be desirable to represent the contours 170 in the sketch template 190 parametrically, such as by representing each contour with a curve approximation 230 (such as B-spline approximation) with a small number of landmark points 240, 260 corresponding to important features (e.g., articulated landmark points 240 and high curvature landmark points 260) extracted from the contour. The curve approximations 230 may also be created directly from the strokes 140, 150 or from contours 170 compute in alternate ways. When each curve approximation 230 has a corresponding pair of landmark points 240, 260, the sketch template 190 may be represented as K={Cᵢ({p_{A}^{j}},{p_{C}^{k}},θᵢ)} where Cᵢ stands for the ith curve approximation having two landmark points {p_{A}^{j}} and {p_{C}^{k}} and approximation parameters θᵢ.

As described above, the sketch template 190 may be altered, as shown in operation 200, by the user after it is created. Since the sketch template 190 preserves the shapes of objects, personalization or stylization, as shown in operation 200, may be performed by manipulating the positions of landmark points 240, 260 and/or adjusting the curve approximation parameters. For example, a “wild” personalization style could space out the landmark points 240, 260 and increase the magnitude of the parameters defining the curve approximations 230. A variety of other styles may be supported by performing sketch template 190 warping. A style set Y={Y₁,Y₂, . . . } may be constructed beforehand for each type of personalization, shown as operation 200, where the elements are various personalization or stylization operations. Each stylization operation may include operation functions for the high curvature landmark points 260 and articulated landmark points 240, for example Yᵢ={F_{A}ⁱ,F_{C}ⁱ,Sⁱ}, where F_{A}ⁱ,F_{C}ⁱ stand for operations on articulated landmark points and high curvature landmark points respectively, and Sⁱ represents the curve sampling method such as B-sampling, B-spline, etc. These functions, whether linear or non-linear, may be used to adjust the positions of the landmark points 240, 260 according to the predefined style. For example, as shown in FIG. 2, personalization exaggerates one ear 250 of the toy bear sketch template 190. Personalization, as shown in operation 200, may be performed either automatically (e.g., users just select a pre-defined style) or interactively (e.g., users point out specific parts (e.g. the ear 250) to be personalized and select one or more styles).

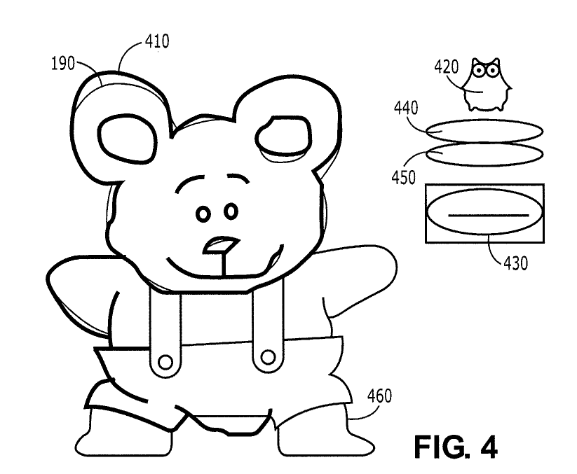

As described above, the sketch template 190 that is created may be used to practice drawing. As shown in FIG. 4, a tracing functions lets users trace a given sketch template 190, such as by tracing the template projected upon a touch screen display. During the tracing process, the processor may provide feedback, such as that provided through an expressive mascot 420, to tell the user how he is performing. For example, the expressive mascot 420 may smile when the user is doing well. The feedback may be provided substantially instantaneously. The magnitude of a tracing deviation may be represented by a coloration given to each stroke 140, 150, wherein the meaning of the coloration is defined in a legend 430. For example, a trace 410 that closely follows the template may have a first color, while a trace that more greatly deviates from the template may have a second color. Further, when the user finishes tracing, the processor may provide an overall score 440 along with a completion percentage 450 if there is an unfinished portion 460.

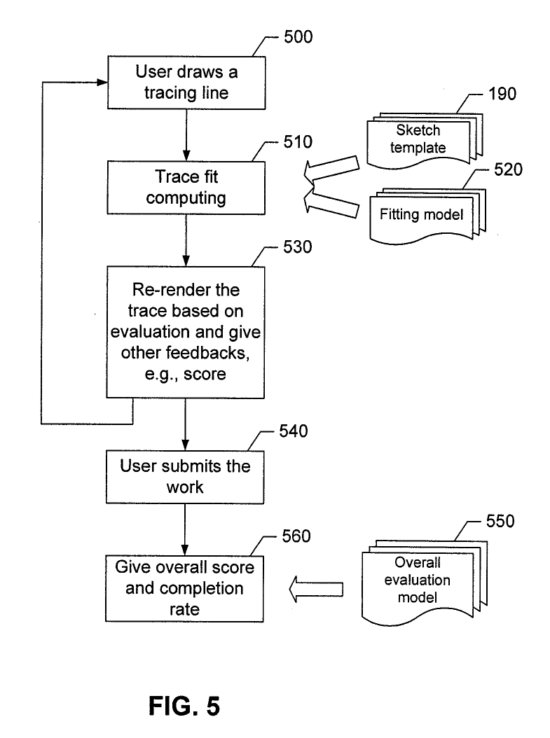

FIG. 5 demonstrates the operational flow of the tracing algorithm. After the user draws a trace 410, as shown in operation 500, on the sketch template 190, the fitness of the trace may be computed, as shown in operation 510, by the processor based on a fitting model 520, which combines several criteria (smoothness, average deviation from sketch template, maximum faults, drawing speed, etc.) into a weighted combination:

$$S = {\sum }_{i = 1}^{N} {w}_{i} {F}_{{i}^{′}} ,$$

where S stands for the score of the current trace, Fᵢ represents the ith criteria value and wᵢ represents its relative weight. With regard to drawing speed criteria, they may measure performance with respect to consistency of speed of drawing, total completion time, or other similar time based measures. The output of the above equation is a score of the current trace 410, as shown in operation 530, and it may also determine a coloration for the trace based on the deviation. This scoring may be iteratively repeated by the processor until the user submits his work, as shown in operation 540. The processor may then employ an overall fitting model 550 to calculate the overall score, as shown in operation 560, of the tracing 410, which may take the weighted trace scores, the completion rate, and the drawing time into account. Embodiments of the present invention therefore essentially provide feedback, such as instant feedback, to the user and accurately point out what has been done well, and what could use improvement.

As described above, FIGS. 2, 3 and 5 are flowcharts of a system, method and program product according to exemplary embodiments of the invention. It will be understood that each block or step of the flowchart, and combinations of blocks in the flowchart, may be implemented by various means, such as hardware, firmware, and/or software including one or more computer program instructions. For example, one or more of the procedures described below may be embodied by computer program instructions. In this regard, the computer program instructions which embody the procedures described below may be stored by a memory device of the mobile terminal 10 (or other apparatus) and executed by a processor in the mobile terminal (e.g., the processor 20) (or other apparatus). As will be appreciated, any such computer program instructions may be loaded onto a computer or other programmable apparatus (i.e., hardware) to produce a machine, such that the instructions which execute on the computer or other programmable apparatus create means for implementing the functions specified in the flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowchart may support combinations of means for performing the specified functions, combinations of steps for performing the specified functions and program instruction means for performing the specified functions. It will also be understood that one or more blocks or steps of the flowchart, and combinations of blocks or steps in the flowchart, may be implemented by special purpose hardware-based computer systems which perform the specified functions or steps, or combinations of special purpose hardware and computer instructions.

In an exemplary embodiment, an apparatus for performing the methods of FIGS. 2, 3, and 5 as described above may comprise a processor (e.g., the processor 20) configured to perform some or each of the operations (100-220, 300-330, and 510-560) described above. The processor may, for example, be configured to perform the operations (100-220, 300-330, and 510-560) by performing hardware implemented logical functions, executing stored instructions, or executing algorithms for performing each of the operations. Alternatively, the apparatus may comprise means, such as the processor, for performing each of the operations described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus comprising a processor configured to:
provide for a display of an image;
receive a template creation input comprising one or more strokes and corresponding at least in part to the image;
determine a curve approximation corresponding to at least one stroke of the one or more strokes; and
provide a sketch template that comprises at least the curve approximation.

2. The apparatus according to claim 1, wherein the processor is configured to determine a lowest data cost contour and translate the lowest data cost contour into the curve approximation.

3. The apparatus according to claim 1, wherein the processor is configured to provide for capture of the image.

4. The apparatus according to claim 1, wherein the processor is configured to output a tracing feedback based at least in part on one or more differences between the sketch template and a tracing input.

5. The apparatus according to claim 4, wherein the processor is further configured to calculate and provide for display of a completion value that indicates how much of the sketch template has been traced by the tracing input.

6. The apparatus according to claim 4, wherein the processor is further configured to differentiate one or more portions of the tracing input based on a distance between the tracing input and one or more corresponding portions of the sketch template.

7. The apparatus according to claim 1, wherein the processor is further configured to provide a speed feedback based at least in part on a time taken to complete a tracing input.

8. The apparatus according to claim 1, wherein the processor is further configured to provide for transmission of the sketch template and reception of an externally created sketch template.

9. The apparatus according to claim 1, wherein the processor is further configured to provide for conversion of one or more of the strokes from a closed condition to an open condition.

10. The apparatus according to claim 1, wherein the processor is further configured to modify one or more characteristics of the curve approximation so as to customize the sketch template.

11. A method comprising:
providing for a display of an image;
receiving a template creation input comprising one or more strokes and corresponding at least in part to the image;
determining a curve approximation corresponding to at least one stroke of the one or more strokes; and
providing a sketch template that comprises at least the curve approximation.

12. The method of claim 11, further comprising outputting a tracing feedback based at least in part on one or more differences between the sketch template and a tracing input.

13. The method of claim 12, further comprising calculating and providing for display of a completion value that indicates how much of the sketch template has been traced by the tracing input.

14. The method of claim 12, further comprising differentiating one or more portions of the tracing input based on a distance between the tracing input and one or more corresponding portions of the sketch template.

15. The method of claim 11, further comprising modifying one or more characteristics of the curve approximation so as to customize the sketch template.

16. A computer program product comprising at least one computer-readable storage medium having computer-executable program instructions stored therein, the computer-executable program instructions comprising:
a program instruction configured to provide for display of an image;
a program instruction configured to receive a template creation input comprising one or more strokes and corresponding at least in part to the image;
a program instruction configured to determine a curve approximation corresponding to at least one stroke of the one or more strokes; and
a program instruction configured to provide a sketch template that comprises at least the curve approximation.

17. The computer program product according to claim 16, wherein the computer-executable program instructions further comprise a program instruction configured to output a tracing feedback based at least in part on one or more differences between the sketch template and a tracing input.

18. The computer program product according to claim 16, wherein the computer-executable program instructions further comprise a program instruction configured to calculate and provide for display of a completion value that indicates how much of the sketch template has been traced by the tracing input.

19. The computer program product according to claim 16, wherein the computer-executable program instructions further comprise a program instruction configured to differentiate one or more portions of the tracing input based on a distance between the tracing input and one or more corresponding portions of the sketch template.

20. The computer program product according to claim 16, wherein the computer-executable program instructions further comprise a program instruction configured to modify one or more characteristics of the curve approximation so as to customize the sketch template.
